(19) United States
(12) Patent Application Publication
(10) Pub. No.: US 2016/0007141 A1
(43) Pub. Date: Jan. 7, 2016

(54) Linking Media Access Between Devices

(71) Applicants: Raghu ANANTHARANGACHAR, Bangalore (IN); HEWLETT-PACKARD DEVELOPMENT COMPANY, L.P., Houston, TX (US)

(72) Inventor: Raghu Anantharangachar, Bangalore (IN)

(21) Appl. No.: 14/763,218

(22) PCT Filed: Jan. 31, 2013
(86) PCT No.: PCT/IN2013/000066

§ 371 Date: Jul. 24, 2015

(51) Int. Cl. H04W 4/00

(52) U.S. Cl. CPC H04W 4/008

(57) ABSTRACT

Examples of the present disclosure include methods, systems, and machine-readable and executable instructions for linking media access between devices. An example method can include receiving by a stationary media transfer device a media link request from a mobile wireless communication device and linking access to a media file between the stationary media transfer device and the mobile wireless communication device based upon a transfer of metadata stored in a cloud concerning an application state of the media file.

### BACKGROUND

Users may want to use multiple devices in the context of playing or storing media files. A number of implementations may enable play of media files on multiple devices. However, such implementations may not support both remote and local transfer of play or storage of media between the devices. Such implementations also may not enable a smooth transition in the play and/or storage of a media file when switching between devices.

### BRIEF DESCRIPTION OF THE DRAWINGS

FIG. 1 illustrates a block diagram of an example of a system for linking media access between devices according to the present disclosure.

FIGS. 2A-2B illustrate examples of linking media access between devices according to the present disclosure.

FIG. 3 illustrates a block diagram of an example of a computer-implemented method for linking media access between devices according to the present disclosure.

FIG. 4 illustrates a block diagram of an example of a cloud system for linking media access between devices according to the present disclosure.

### DETAILED DESCRIPTION

Users of mobile wireless communication devices, for example, cellular telephones (e.g., cell phones), smart phones, personal digital assistants (e.g., PDAs), laptop computers, etc., may want to use multiple devices in the context of playing and/or storing accessed media files, for example, audio and/or video files (e.g., songs, albums, movies, video clips, such as YouTube™, etc.), documents, and configuration files, etc. The users may seek operational continuity in play of media files transferred from one device to another. For example, if the user is viewing a media file on one device and has transferred display of the media file to another device, the user may intend for the same media file to continue playing on the other device without re-starting (e.g., from a same point in a sequence of images as when display of the media file was transferred) for continued viewing by the user and/or another viewer. A remote user browsing media files (e.g., accessed via the Internet) on a mobile wireless communication device may, for example, intend both to view the media file on the mobile device and to transfer access to the media file to a stationary media transfer device that enables display of the media file on a stationary media player (e.g., a television, computer monitor, etc., at home) and/or storage of the media file (e.g., in a media storage database associated with the stationary media transfer device) for later viewing.

Examples of the present disclosure include methods, systems, and machine-readable and executable instructions for linking media access between devices. An example method can include receiving by a stationary media transfer device a media link request from a mobile wireless communication device and linking access to a media file between the stationary media transfer device and the mobile wireless communication device based upon a transfer of metadata stored in a cloud concerning an application state of the media file.

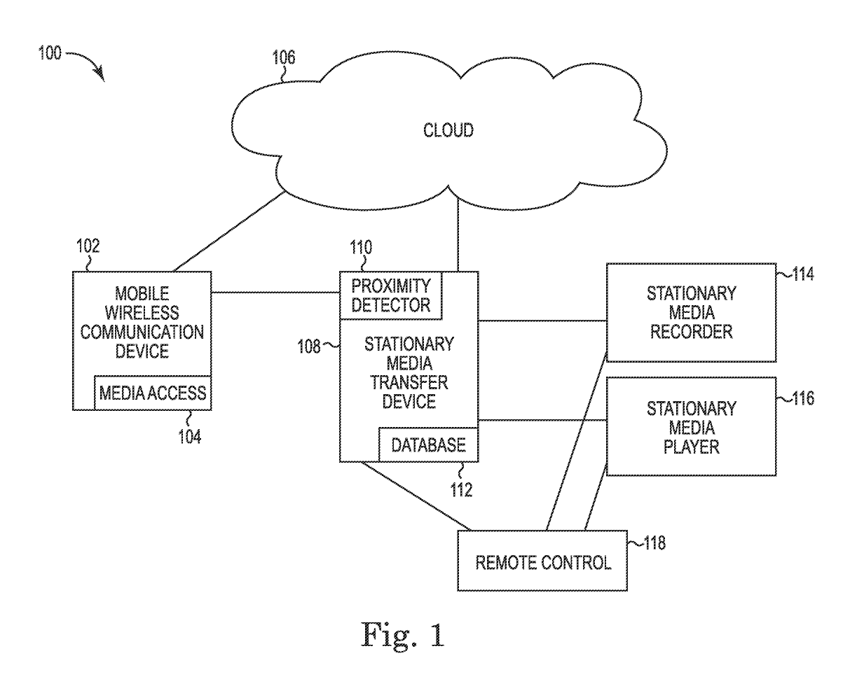

FIG. 1 illustrates a block diagram of an example of a system for linking media access between devices according to the present disclosure. In the detailed description of the present disclosure, reference is made to the accompanying drawings that form a part hereof and in which is shown by way of illustration how examples of the disclosure may be practiced. These examples are described in sufficient detail to enable one of ordinary skill in the art to practice the examples of this disclosure and it is to be understood that other examples may be utilized and that process, electrical, and/or structural changes may be made without departing from the scope of the present disclosure. As used herein, “a” or “a number of” an element and/or feature can refer to one or more of such elements and/or features. Further, where appropriate, as used herein, “for example’ and “by way of example” should be understood as abbreviations for “by way of example and not by way of limitation”.

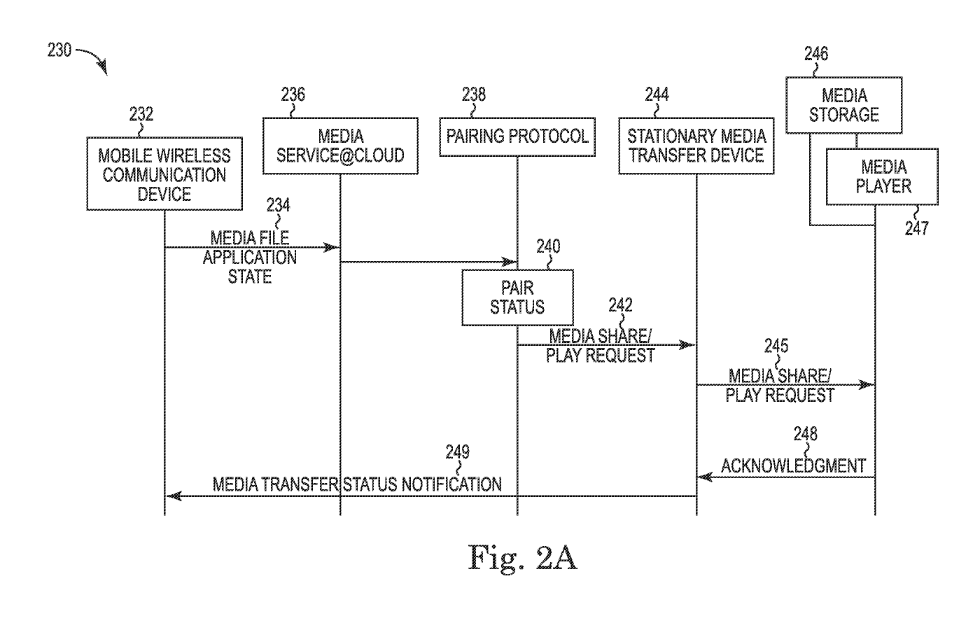

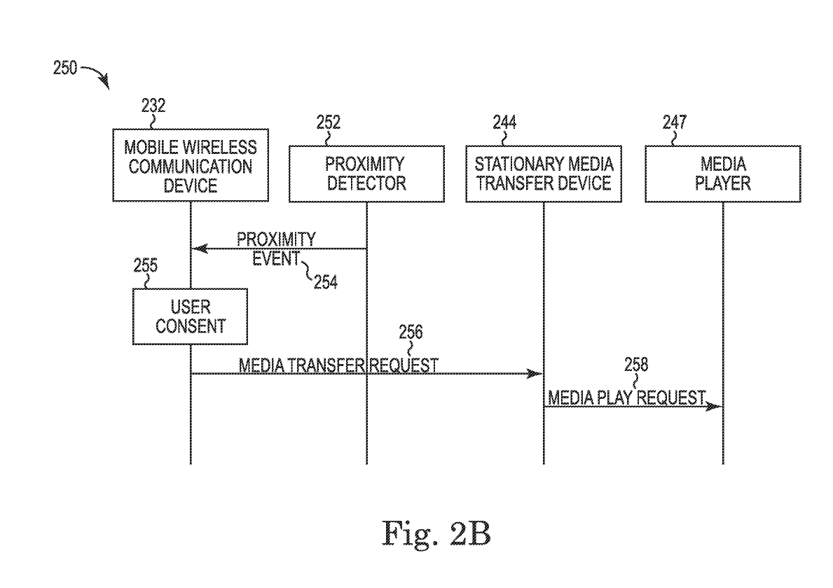

The figures herein follow a numbering convention in which the first digit or digits correspond to the drawing figure number and the remaining digits identify an element or component in the drawing. Similar elements or components between different figures may be identified by the use of similar digits. For example, 111 may reference element “11” in FIG. 1, and a similar element may be referenced as 211 in FIG. 2. Elements shown in the various figures herein may be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense.

The example of the system 100 illustrated in FIG. 1 shows a mobile wireless communication device 102, as described herein, having a media access functionality 104 that enables access to media files (e.g., for browsing, playing, downloading, etc.) via the Internet, among other possible sources for media files, as described herein. The mobile wireless communication device 102 and/or the media access functionality 104 can be configured to functionally interact with a cloud 106.

Among other capabilities, the cloud 106 can be utilized for “cloud computing”, which can be considered as the use of computing resources (e.g., hardware, software, logic, etc.) that are delivered as a service over a communications network (e.g., in a wired and/or wireless manner over the Internet). Cloud computing can enable securely entrusting remote services with a user's data, passwords, software, documents, and computations, etc. Cloud providers can manage the infrastructure and platforms on which the resource applications run and allowed users can be provided access to resource application software and databases.

The cloud 106 can be used to store metadata concerning media files accessed by the mobile wireless communication device 102. Such metadata can include metadata about a particular media file that when transferred to another device enables the other device to access the same media file. For example, a uniform resource locator (URL) can be included in the metadata. A URL is a formatted text string used, for example, by web browsers, e-mail clients, and other software to identify a network resource on the Internet. Network resources can be media files that are plain web pages, other text documents, graphics, audio/video presentations, and/or programs such as configuration files, among others. The metadata stored in the cloud can also include an application state of the media file. The application state metadata can include information defining, for example, at what point in a video display the user stopped viewing the video in order to transfer the media file access to another device (e.g., to enable viewing and/or storing the media file continuously from that point on the other device).

The mobile wireless communication device 102 can directly and/or indirectly interact with a stationary media transfer device 108. Direct interaction can be enabled via a proximity detector 110 when the mobile wireless communication device 102 is in close proximity to (e.g., is a short range from) the stationary media transfer device 108. The proximity detector 110 can detect that the mobile wireless communication device 102 is in close proximity based upon detection of signals that travel a relatively short range (e.g., short-range signals such as low power infrared, ultraviolet, laser, radio, microwave signals, etc.) compared to signals with higher power and/or capability of transmitting through obstacles (e.g., long-range signals), which can be utilized for remote linkage of the mobile wireless communication device 102 and the stationary media transfer device 108 (e.g., via the cloud 106). Depending upon a distance and/or obstacles between the mobile wireless communication device 102 and the stationary media transfer device 108, such short-range and/or long-range signals can, for example, be emitted by the mobile wireless communication device 102.

As described herein, upon detection of the signal by the proximity detector 110, the stationary media transfer device 108 can be enabled to access the metadata in the cloud 106 concerning the media file. Before or after accessing the metadata in the cloud 106, the stationary media transfer device 108 can send an option (e.g., via the mobile wireless communication device 102) to the user to enable transfer of play and/or storage of the media file via the stationary media transfer device 108. If the user consents to such a transfer while in close proximity to the stationary media transfer device 108, the media file can be accessed via use of the metadata and/or application state concerning the media file that is stored in the cloud 106 and the media file can be played on a stationary media player 116, as described herein. In some examples of the present disclosure, a user's mobile wireless communication device 102 that is not in close proximity to (e.g., is remote from) the stationary media transfer device 108 can enable access to a media file via the cloud 106 through the stationary media transfer device 108 to allow play of the media file (e.g., either from the beginning or continuously from the point of transfer) on one or more of the remote stationary media players 116 (e.g., for viewing by a number of remote viewers).

Alternatively or in addition, if the user instructs such a transfer when remote from the stationary media transfer device 108 or consents to such a transfer while in close proximity to the stationary media transfer device 108, the media file can be accessed via use of the metadata and/or application state concerning the media file that is stored in the cloud 106. In various examples, the metadata and/or application state concerning the media file and/or the accessed media file itself can be stored in a database 112 of the stationary media transfer device 108 and/or in a stationary media recorder 114 associated with the stationary media transfer device 108. The user and/or the remote viewers can control display, retrieval, and/or storage, among other functions performed by the stationary media transfer device 108, the stationary media recorder 114, and/or the stationary media player 116 with a remote control 118 and/or by operation of manual controls (not shown).

As described herein, a stationary media transfer device can be a stand-alone or an embedded hub for connection and/or coordination via the cloud, as described herein, of mobile wireless communication devices, stationary media recorders, and/or stationary media players of a number of users. Linking of the various devices can be securely controlled via pairing protocols (e.g., defining authorized and/or allowed users, devices, types of media files, etc.) stored in the cloud.

For example, the stationary media transfer device can download a media file (e.g., a video) and store it in a specified media storage folder. The user can select to play the video already downloaded by the stationary media transfer device. The user can select to play the video immaterial of where the user is, that is, either near (e.g., in short-range from, proximal to, etc.) the stationary media transfer device or in a location remote from the stationary media transfer device. This can enable the user to use the mobile wireless communication device for browsing and use the stationary media transfer device for storing media files and/or as a stationary media player (e.g., a television, a computer monitor, etc.) for viewing play of the media files.

By way of example and not by way of limitation, a Hewlett-Packard Vayu Internet Service Device (VInD) is such a stationary media transfer device. VInD can include a number of random access memories (RAM), storages (e.g., flash, hard drive, among others), high-definition multimedia interfaces (HDMI), web browsers, universal serial buses (USB), audio/video ports, infrared connectivities, proximity detectors, Ethernet ports, wireless features (e.g., WiFi, Bluetooth, ZigBee, etc.), modems, library databases for storing/organizing video files, audio files, graphics, documents, etc., wired and/or wireless keyboards, and/or microphone and/or speaker inputs/outputs, among other features.

Users may use multiple heterogeneous devices to get rich user experiences. Each device may have its own storage, compute, and/or form factors. The present disclosure enables use of a mobile wireless communication device and a stationary media transfer device for seamless transfer of media files when the user moves to various locations with the mobile wireless communication device. When the mobile wireless communication device comes in close proximity to the stationary media transfer device, which is connected to a stationary media player device, the user can be prompted with the option of pausing the play of a media file on the mobile wireless communication device and starting play on the media player device. If the user consents, the play of the media file can be paused (e.g., stopped) on the mobile wireless communication device and be automatically started on the media player device from the point where it paused on the mobile wireless communication device.

In addition, as described herein, when the user moves away from the stationary media transfer device, the user can again be prompted with the option of transferring play of the media file to the mobile wireless communication device. If the user consents, the media file can stop playing on the stationary media player device and automatically start playing again on the mobile wireless communication device.

It is possible for the user to control the play and/or storage of the media files in various ways. For example, the user can have an option to continue to use the mobile wireless communication device for watching the media file with the content being streamed to the stationary media transfer device (e.g., for storage and/or play) without actually being downloaded (e.g., stored) directly to the mobile wireless communication device. For example, a media file being transferred for continuous play to the stationary media player device (e.g., in the middle of play of a video file) can be stored, via the stationary media transfer device, from the beginning in a media storage file. In addition, play of the media file can be paused on the stationary media recorder device or the stationary media player device (e.g., using the remote control described with regard to FIG. 1) and play of the media file can be continued at a later time.

FIGS. 2A-2B illustrate examples of linking media access between devices according to the present disclosure. The example 230 shown in FIG. 2A illustrates media file share requests and/or media file play requests being sent from a user's mobile wireless communication device 232 to a number of files for media storage 246 and/or to a number of media players 247. The example 230 shown in FIG. 2A is applicable to situations where, for example, the user of the mobile wireless communication device 232, or an application associated therewith, can select a media file, as described herein, and initiate a request to share (e.g., send to a number of authorized, or paired, recipients and/or devices) and/or play the media file sent by the mobile wireless communication device 232 to a media service in the cloud 236. As described herein, metadata identifying the media file (e.g., including the URL) can be sent with the request to be stored in the cloud and/or the metadata identifying the media file can already be stored in the cloud and the request can become associated (e.g., stored) therewith.

The metadata sent to the media service in the cloud 236 can also include the media file application state 234. An application state can be defined as information that enables recreation of the application (e.g., the media file that is being linked from one device to another device) in the same state. For example, the media file application state 234 information can contain the media file name and/or tag and a current time and/or position indicator (e.g., including how much time and/or to what point in progression an audio or video media file has played before the request for transfer interrupts (e.g., pauses, stops, etc.) play of the media file on the mobile wireless communication device 232).

The media service in the cloud 236 can invoke a pairing protocol 238 to verify a pair status 240 to determine (e.g., confirm or deny) whether the mobile wireless communication device 232 is authorized to be paired (e.g., linked) with an intended recipient's stationary media transfer device 244. If the pair status 240 is confirmed, the media share/play request 242 can be forwarded to the intended recipient's stationary media transfer device 244. Once the paring of the devices is done, the devices are able to securely exchange their application states with other devices that are paired with the same stationary media transfer device 244 (e.g., in order to support continuous media file playback, as described herein).

The stationary media transfer device 244 can appropriately direct a media share/play request 245 to direct storage of the media file in a specified media storage file 246 (e.g., via a media downloader for downloading using the URL) and/or to direct a media player 247 to play the media file (e.g., currently and/or at a specified future time). The stationary media transfer device 244 can load and use the media file application state 234 information to, for example, direct the storage and/or play of the media file starting at a particular time and/or point in the progression of the media file.

Following initiation and/or completion of the directed storage and/or play of the media file, the device associated with storage of the media file in the specified media storage file 246 (e.g., the stationary media recorder 114 shown in FIG. 1) and/or the device associated with play of the media file (e.g., the stationary media player 116 shown in FIG. 1) can send an acknowledgement 248 thereof to the stationary media transfer device 244. Notices of failure can be sent if the directed storage and/or play of the media file are unsuccessful. The stationary media transfer device 244 can send (e.g., via an e-mail and/or short message service (SMS) message, among other communication pathways) a media transfer status notification 249 to the mobile wireless communication device 232. The media transfer status notification 249 can provide the status of the media file transfer as, for example, being successfully stored and/or played or a failure to do so, among other possible information (e.g., the time of storage and/or play of the media file, a cause of failure to do so, etc.).

The example 250 shown in FIG. 2B illustrates media file play requests being sent from a user's mobile wireless communication device 232 to a number of media players 247. For example, the mobile wireless communication device 232 can be in close proximity to the stationary media transfer device 244, which can be associated with a proximity detector 252 (e.g., as described at 110 with regard to FIG. 1). In some examples, the proximity detector 252 can be operable continuously to detect mobile wireless communication devices 232 within short-range of the stationary media transfer device 244. Upon detection of the short-range proximity, the proximity detector 252 and/or the associated stationary media transfer device 244 can send a proximity event notification 254 to the mobile wireless communication device 232.

Upon receipt of the proximity event notification 254, the mobile wireless communication device 232 can activate a proximity detection application (not shown). The proximity detection application can attempt to access the stationary media transfer device 244 by starting each of a number of short-range communication protocols (e.g., Wifi, Bluetooth, etc.) and identify which, if any, enable linkage between the mobile wireless communication device 232 and the stationary media transfer device 244 to transfer a media file. Such access being achieved confirms the close proximity determination of the proximity detector 252.

Connection (e.g., linkage) between the mobile wireless communication device 232 and the stationary media transfer device 244 can be accomplished, for example, by registering for notification from one device to the other device if WiFi is turned on and then attempting to connect over WiFi. If the connection is successful, an IP end point (e.g., of an access point) can be returned such that a proximity detection application can identify the stationary media transfer device 244 and determine the communication end point(s). Accordingly, the mobile wireless communication device 232 and the stationary media transfer device 244 can be linked to enable transfer of media files. As described with regard to FIG. 2A, metadata (e.g., the media file application state 234, etc.) can be sent and/or a pairing protocol 238 can, in some examples, be performed though a media service in the cloud 236 or otherwise.

When the mobile wireless communication device 232 and the stationary media transfer device 244 are linked, a notification can be presented to the user, or an enabling application, asking for user consent 255 to enable transfer of display of a media file currently being accessed (e.g., displayed) by the mobile wireless communication device 232 to a media player 247 (e.g., a nearby television). For example, the user can be presented with an option as to whether an accessed video should continue to be displayed on the mobile wireless communication device 232 or whether display of the accessed video should be transferred to the media player 247.

If the user, or the enabling application, consents to such transfer, a media transfer request 256 can be sent from the mobile wireless communication device 232 to the stationary media transfer device 244. The media transfer request 256 can, for example, include metadata identifying the media file currently being accessed (e.g., displayed) on the mobile wireless communication device 232 and its current application state (e.g., metadata that includes the media file's name, version, URL, current time and/or point in progression, etc.). Accordingly, the stationary media transfer device 244 can appropriately direct a media play request 258 to direct the media player 247 to play the media file (e.g., currently and/or at a specified future time). Through use of the metadata (e.g., the current application state), the media file can be played continuously on the media player 247 from the last time and/or point in progression displayed on the mobile wireless communication device 232 before transfer of the media file.

The user can, at any point in time, pause play of the media file on the media player 247 and transfer control back to the mobile wireless communication device 232. For example, the user can continue to display the media file on the mobile wireless communication device 232 continuously or at a later time. Alternatively or in addition, when the mobile wireless communication device 232 is removed from short-range proximity to the stationary media transfer device 244 (e.g., as determined by the proximity detector 252 and/or the proximity detection application for short-range communication), the stationary media transfer device 244 can send metadata (e.g., including the current application state) concerning a media file currently being displayed on the media player 247. The mobile wireless communication device 232 can determine whether the media file is being displayed thereon. If the media file is not being displayed on the mobile wireless communication device 232, the user can be presented an option to enable display of the media file thereon. If the media file is being displayed on the mobile wireless communication device 232, the user can be presented an option to enable a reset of the application state of the media file via the stationary media transfer device 244 to synchronize with that displayed on the media player 247 and continue to play the media file.

As described herein, a trusted network of devices for linking media access between the devices can be created based upon, for example, a user's social network. The user has an option to share the media with anybody in the social network (e.g., acquaintances such as family, friends, co-workers, or others) by authorizing the acquaintances through the pair protocol stored in the cloud, as described herein. The present disclosure describes exchange of metadata stored in the cloud and associated with the media file, including details like the URL of the media file and an application state (e.g., how long the media file has played on the mobile and/or stationary devices), among other possible metadata. The cloud storage is the master file for the metadata. By keeping the metadata for the various media files in synchrony for various devices that the user uses, the application states can be consistent for the various devices. The metadata information stored in the cloud can be synchronized to the devices at periodic intervals and/or whenever the metadata changes.

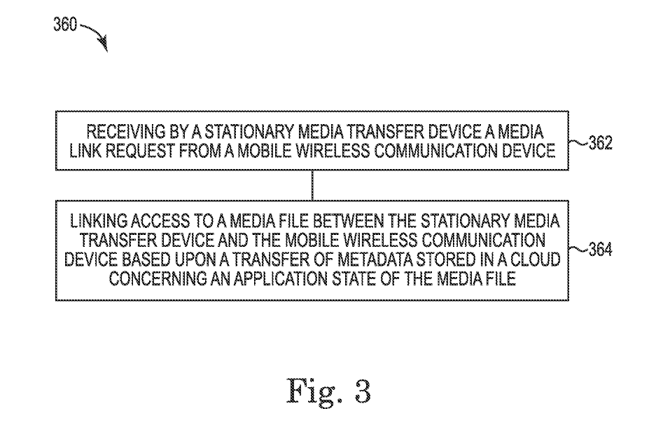

FIG. 3 illustrates a block diagram of an example of a computer-implemented method for linking media access between devices according to the present disclosure. Unless explicitly stated, the method elements described herein are not constrained to a particular order or sequence. Additionally, some of the described examples, or elements thereof, can be performed at the same, or substantially the same, point in time.

As described in the present disclosure, the example of the computer-implemented method 360 for linking media access between devices includes receiving by a stationary media transfer device a media link request from a mobile wireless communication device, as shown in block 362. The method 360 includes linking access to a media file between the stationary media transfer device and the mobile wireless communication device based upon a transfer of metadata stored in a cloud concerning an application state of the media file, as shown in block 364.

In various examples, linking media access between devices can include, as described herein, confirming by a pairing protocol stored in the cloud that the stationary media transfer device and the mobile wireless communication device are paired to enable the linking of access to the media file. In some examples, linking access to the media file between a plurality of stationary media transfer devices and the mobile wireless communication device can be performed based upon the sharing protocol stored in the cloud. For example, a user of the mobile wireless communication device can share the ability to view a particular media file with a plurality of entrusted (e.g., paired) acquaintances that are remotely located by linking access to the media file through the cloud to the acquaintances' stationary media transfer devices.

In some examples, as described herein, a short-range proximity of the mobile device to the stationary media transfer device can be detected to enable the media link request. For example, when within the short-range proximity, an option can be offered (e.g., via optionally clicking an icon by the user) to enable transfer of display of the media file from the mobile wireless communication device, via the stationary media transfer device, to a stationary media player, as described herein.

When outside the short-range proximity, an option can be offered (e.g., via optionally clicking an icon by the user) to enable transfer of display of the media file from a stationary media player, via the stationary media transfer device, to the mobile wireless communication device, as described herein. Alternatively or in addition, when outside the short-range proximity, an option can be offered (e.g., via optionally clicking an icon by the user) to enable transfer of storage of the media file from the mobile wireless communication device, via the stationary media transfer device, to a media storage file, as described herein.

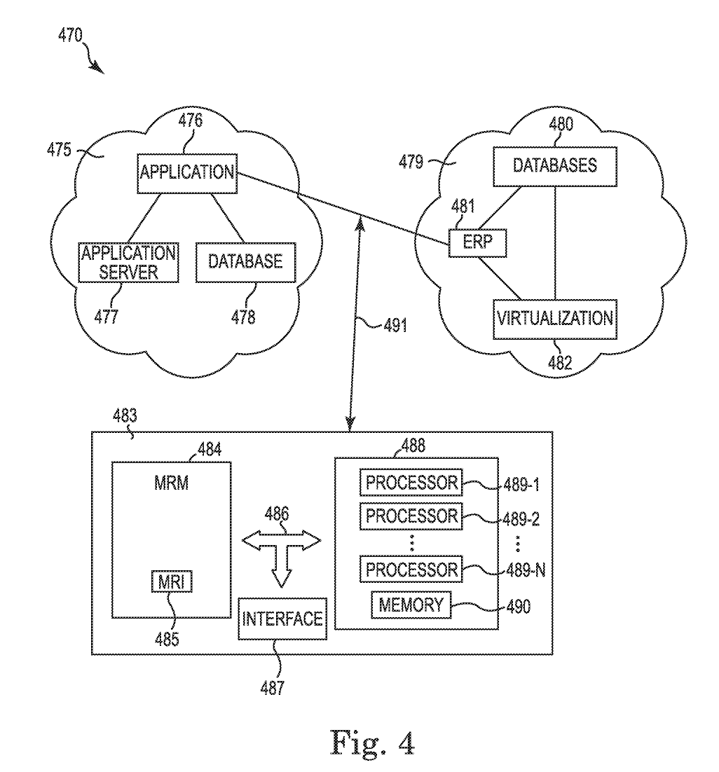

FIG. 4 illustrates a block diagram of an example of a cloud system for linking media access between devices according to the present disclosure. An example system for linking media access between devices is described below as being implemented in the cloud by way of example and not by way of limitation. That is, in some examples of the present disclosure, linking media access between devices can be performed (e.g., at least partially) within an organization utilizing applications, as described herein, accessible and usable through wired communication connections, as opposed to through wireless communication.

In some examples, the system 470 illustrated in FIG. 4 can include a number of cloud systems. In some examples, the number of clouds can include a public cloud system 475 and a private cloud system 479. For example, an environment (e.g., an information technology (IT) environment for linking media access between devices) can include a public cloud system 475 and a private cloud system 479 that can include a hybrid environment and/or a hybrid cloud. A hybrid cloud, for example, can include a mix of physical server systems and dynamic cloud services (e.g., a number of cloud servers). For example, a hybrid cloud can involve interdependencies between physically and logically separated services consisting of multiple systems. A hybrid cloud, for example, can include a number of clouds (e.g., two clouds) that can remain unique entities but that can be bound together.

The public cloud system 475, for example, can include a number of applications 476 (e.g., selected from a number of portals, engines, resources, and/or other applications, as described herein), an application server 477, and a database 478. The public cloud system 475 can include a service provider (e.g., the application server 477) that makes a number of the applications 476 and/or resources (e.g., the database 478) available (e.g., to personnel such as operators and/or users, among others) over the Internet, for example. The public cloud system 475 can be free or offered for a fee. For example, the number of applications 476 can include a number of resources available to the public over the Internet. Personnel and/or devices can access a cloud-based application through a number of interfaces 487 (e.g., via a mobile wireless communication device and/or a stationary media transfer device, an Internet browser installed on a personal computer, among other implementations having the functionalities as described herein). An application server 477 in the public cloud system 475 can include a number of virtual machines (e.g., client environments) to enable linking media access between devices, as described herein. The database 478 in the public cloud system 475 can include a number of databases that operate on a cloud computing platform.

The private cloud system 479 can, for example, include an Enterprise Resource Planning (ERP) system 481, a number of databases 480, and virtualization 482 (e.g., a number of VMs to enable linking media access between devices, as described herein). For example, the private cloud system 479 can include a computing architecture that provides hosted services to a limited number of nodes (e.g., computers and/or VMs thereon) behind a firewall. The ERP 481, for example, can integrate internal and external information across an entire business unit and/or organization (e.g., a provider of services for linking media access between devices). The number of databases 480 can include an event database, an event archive, a central configuration management database (CMDB), a performance metric database, and/or databases for a number of applications, among other databases. Virtualization 482 can, for example, include the creation of a number of virtual resources, such as a hardware platform, an operating system, a storage device, and/or a network resource, among others.

In some examples, the private cloud system 479 can include a number of applications and an application server as described for the public cloud system 475. In some examples, the private cloud system 479 can similarly include a service provider that makes a number of the applications and/or resources (e.g., the databases 480 and/or the virtualization 482) available for free or for a fee (e.g., to personnel such as the operator and/or the user, among others) over, for example, a local area network (LAN), a wide area network (WAN), a personal area network (PAN), and/or the Internet, among others. The public cloud system 475 and the private cloud system 479 can be bound together, for example, through one or more of the number of applications (e.g., 476 in the public cloud system 475) and/or the ERP 481 in the private cloud system 479 to enable dynamically linking media access between devices, as described herein.

The system 470 can include a number of computing devices 483 having machine readable memory (MRM) resources 484 and processing resources 488 with machine readable instructions (MRI) 485 (e.g., computer readable instructions) stored in the MRM 484 and executed by the processing resources 488 to, for example, enable linking media access between devices, as described herein. The computing devices 483 can be any combination of hardware and/or program instructions (e.g., MRI) configured to, for example, enable linking media access between devices, as described herein. The hardware, for example, can include a number of interfaces 487 (e.g., graphic user interfaces (GUIs)) and/or a number of processing resources 488 (e.g., processors 489-1, 489-2, . . . , 489-N), the MRM 484, etc. The processing resources 488 can include memory resources 490 and the processing resources 488 (e.g., processors 489-1, 489-2, . . . , 489-N) can be coupled to the memory resources 490. The MRI 485 can include instructions stored on the MRM 484 that are executable by the processing resources 488 to execute one or more of the various actions, functions, calculations, data manipulations and/or storage, etc., as described herein.

The computing devices 483 can include the MRM 484 in communication through a communication path 486 with the processing resources 488. For example, the MRM 484 can be in communication through a number of application servers (e.g., Java application servers) with the processing resources 488. The computing devices 483 can be in communication with a number of tangible non-transitory MRMs 484 storing a set of MRI 485 executable by one or more of the processors (e.g., processors 489-1, 489-2, . . . , 489-N) of the processing resources 488. The MRI 485 can also be stored in remote memory managed by a server and/or can represent an installation package that can be downloaded, installed, and executed. The MRI 485, for example, can include a number of modules for storage of particular sets of instructions to direct execution of particular functions, as described herein.

Processing resources 488 can execute MRI 485 that can be stored on an internal or external non-transitory MRM 484. The non-transitory MRM 484 can be integral, or communicatively coupled, to the computing devices 483, in a wired and/or a wireless manner. For example, the non-transitory MRM 484 can be internal memory, portable memory, portable disks, and/or memory associated with another computing resource. A non-transitory MRM (e.g., MRM 484), as described herein, can include volatile and/or non-volatile storage (e.g., memory). The processing resources 488 can execute MRI 485 to perform the actions, functions, calculations, data manipulations and/or storage, etc., as described herein. For example, the processing resources 488 can execute MRI 485 to enable dynamically linking media access between devices, as described herein.

The MRM 484 can be in communication with the processing resources 488 via the communication path 486. The communication path 486 can be local or remote to a machine (e.g., computing devices 483) associated with the processing resources 488. Examples of a local communication path 486 can include an electronic bus internal to a machine (e.g., a computer) where the MRM 484 is volatile, non-volatile, fixed, and/or removable storage medium in communication with the processing resources 488 via the electronic bus. Examples of such electronic buses can include Industry Standard Architecture (ISA). Peripheral Component Interconnect (PCI), Advanced Technology Attachment (ATA), Small Computer System Interface (SCSI), Universal Serial Bus (USB), among other types of electronic buses and variants thereof.

The communication path 486 can be such that the MRM 484 can be remote from the processing resources 488, such as in a network connection between the MRM 484 and the processing resources 488. That is, the communication path 486 can be a number of network connections. Examples of such network connections can include LAN, WAN, PAN, and/or the Internet, among others. In such examples, the MRM 484 can be associated with a first computing device and the processing resources 488 can be associated with a second computing device (e.g., computing devices 483). For example, such an environment can include a public cloud system (e.g., 475) and/or a private cloud system (e.g., 479) to enable linking media access between devices, as described herein.

In various examples, the processing resources 488, the memory resources 484 and/or 490, the communication path 486, and/or the interfaces 487 associated with the computing devices 483 can have a connection 491 (e.g., wired and/or wirelessly) to a public cloud system (e.g., 475) and/or a private cloud system (e.g., 479). The system 474 can utilize software, hardware, firmware, and/or logic for linking media access between devices, as described herein. The system 470 can be any combination of hardware and program instructions. The connection 491 can, for example, enable the computing devices 483 to directly and/or indirectly control (e.g., via the MRI 485 stored on the MRM 484 executed by the processing resources 488) functionality of a number of the applications 476 accessible in the cloud. The connection 491 also can, for example, enable the computing devices 483 to directly and/or indirectly receive input from the number of the applications 476 accessible in the cloud.

In various examples, the processing resources 488 coupled to the memory resources 484 and/or 490 can execute MRI 485 to enable the computing devices 483 in the system 470 with a connection 491 to the public cloud 475 and/or the private cloud 479 to send to a stationary media transfer device a media link request including metadata stored in the cloud concerning a media file accessed by a mobile wireless communication device, confirm by a pairing protocol stored in the cloud that the stationary media transfer device and the mobile wireless communication device are paired, and access the media file by the stationary media transfer device based upon the metadata.

In some examples, the media link request can include a media storage instruction that causes the stationary media transfer device to direct storage of the media file (e.g., to a specified media storage file in the stationary media transfer device or in an associated stationary media recorder that is connected by wire and/or wirelessly). The media link request can, in some examples, include a media display instruction that causes the stationary media transfer device to direct display of the media file by a media player. In various examples, the mobile wireless communication device, via the stationary media transfer device, can be notified about execution of instructions in the media link request either to store and/or play the media file.

A computing system to link media access between devices can include memory resources and processor resources coupled to the memory resources, as described herein. The computing system can be utilized to detect, via input from a proximity detector, a short-range proximity of a mobile wireless communication device to a stationary media transfer device, to send a media transfer request from the mobile wireless communication device to the stationary media transfer device, and to play on a media player, via the stationary media transfer device, a media file accessed by the mobile wireless communication device, as described with regard to FIGS. 1 and 2B, for example.

In some examples, to send the media transfer request can be conditioned upon user consent, as described with regard to FIG. 2B, for example. In some examples, to send the media transfer request can include to transfer media file access metadata that is stored in the cloud, as described with regard to FIGS. 2A and 2B, for example. In some examples, to play the media file can include a transfer of metadata stored in the cloud that enables recreation of the application state of the media file, as described with regard to FIGS. 2A and 2B, for example.

Advantages of linking media access between devices, as described herein, can include using cloud-mediated group-based metadata sharing for linking access of user chosen media files between short-range (e.g., close proximity) and/or long-range (e.g., remote) devices capable of playing and/or storing the media files, enabling existing media access applications (e.g., various types of mobile wireless communication devices) to share and/or play media files on other devices in a secure manner (e.g., via use of the pairing protocol stored in the cloud), enabling continuity of media playback (e.g., by linking media access between a mobile wireless communication device and a stationary media player via a stationary media transfer device), and/or automatically detecting the proximity of one device to another device and prompting the user to transfer media file play from one device to the other device. Other advantages can include the present approach being based upon platform notification such that the application logic is not altered to support media transfer, allowing users and/or authorized (e.g., paired) acquaintances to more effectively integrate linkage of access to and/or transfer of media files between multiple devices, and/or allowing for delegation of tasks to the stationary media transfer device to reduce a battery charge drain and/or application overload on the mobile wireless communication device.

As used herein, “logic” is an alternative or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processing resource.

As described herein, plurality of storage volumes can include volatile and/or non-volatile storage (e.g., memory). Volatile storage can include storage that depends upon power to store information, such as various types of dynamic random access memory (DRAM), among others. Non-volatile storage can include storage that does not depend upon power to store information. Examples of non-volatile storage can include solid state media such as flash memory, electrically erasable programmable read-only memory (EEPROM), phase change random access memory (PCRAM), magnetic storage such as a hard disk, tape drives, floppy disk, and/or tape storage, optical discs, digital versatile discs (DVD), Blu-ray discs (BD), compact discs (CD), and/or a solid state drive (SSD), etc., as well as other types of machine readable media.

It is to be understood that the descriptions presented herein have been made in an illustrative manner and not a restrictive manner. Although specific examples systems, machine readable media, methods and instructions, for example, for linking media access between devices have been illustrated and described herein, other equivalent component arrangements, instructions, and/or device logic can be substituted for the specific examples presented herein without departing from the spirit and scope of the present disclosure.

The specification examples provide a description of the application and use of the systems, machine readable media, methods, and instructions of the present disclosure. Since many examples can be formulated without departing from the spirit and scope of the systems, machine readable media, methods, and instructions described in the present disclosure, this specification sets forth some of the many possible example configurations and implementations.

What is claimed:

1. A computer-implemented method for linking media access between devices, comprising:
receiving by a stationary media transfer device a media link request from a mobile wireless communication device; and
linking access to a media file between the stationary media transfer device and the mobile wireless communication device based upon a transfer of metadata stored in a cloud concerning an application state of the media file.

2. The method of claim 1, comprising confirming by a pairing protocol stored in the cloud that the stationary media transfer device and the mobile wireless communication device are paired to enable the linking of access to the media file.

3. The method of claim 2, comprising linking access to the media file between a plurality of stationary media transfer devices and the mobile wireless communication device based upon the sharing protocol stored in the cloud.

4. The method of claim 1, comprising detecting a short-range proximity of the mobile device to the stationary media transfer device to enable the media link request.

5. The method of claim 4, comprising offering when within the short-range proximity an option to enable transfer of display of the media file from the mobile wireless communication device, via the stationary media transfer device, to a stationary media player.

6. The method of claim 4, comprising offering when outside the short-range proximity an option to enable transfer of display of the media file from a stationary media player, via the stationary media transfer device, to the mobile wireless communication device.

7. The method of claim 4, comprising offering when outside the short-range proximity an option to enable transfer of storage of the media file from the mobile wireless communication device, via the stationary media transfer device, to a media storage file.

8. A non-transitory machine-readable medium storing a set of instructions to link media access between devices, wherein the set of instructions is executable by a processing resource to cause a computing system to:
send to a stationary media transfer device a media link request comprising metadata stored in a cloud concerning a media file accessed by a mobile wireless communication device;
confirm by a pairing protocol stored in the cloud that the stationary media transfer device and the mobile wireless communication device are paired; and
access the media file by the stationary media transfer device based upon the metadata.

9. The medium of claim 9, wherein the media link request comprises a media storage instruction that causes the stationary media transfer device to direct storage of the media file.

10. The medium of claim 9, wherein the media link request comprises a media display instruction that causes the stationary media transfer device to direct display of the media file by a media player.

11. The medium of claim 9, comprising to notify the mobile wireless communication device, via the stationary media transfer device, about execution of instructions in the media link request either to store and play the media file.

12. A computing system to link media access between devices, comprising:
a memory;
a processor resource coupled to the memory, to:
detect, via input from a proximity detector, a short-range proximity of a mobile wireless communication device to a stationary media transfer device:
send a media transfer request from the mobile wireless communication device to the stationary media transfer device; and
play on a media player, via the stationary media transfer device, a media file accessed by the mobile wireless communication device.

13. The system of claim 12, wherein to send the media transfer request is conditioned upon user consent.

14. The system of claim 12, wherein to send the media transfer request comprises to transfer media file access metadata that is stored in a cloud.

15. The system of claim 12, wherein to play the media file comprises a transfer of metadata stored in a cloud that enables recreation of the application state of the media file.
